(19) United States
(12) Patent Application Publication
(10) Pub. No.: US 2022/0037736 A1
(43) Pub. Date: Feb. 3, 2022

(54) BATTERY AND MOTOR VEHICLE WITH BATTERY

(71) Applicant: AUDI AG, Ingolstadt (DE)

(72) Inventor: Marvin CZECH, Ingolstadt (DE)

(73) Assignee: AUDI AG, Ingolstadt (DE)

(21) Appl. No.: 17/385,068

(22) Filed: Jul. 26, 2021

(30) Foreign Application Priority Data
Jul. 29, 2020 (DE) 102020120042.0

(51) Int. Cl. H01M 50/367; H01M 50/204

(52) U.S. Cl. CPC H01M 50/367; H01M 2220/20; H01M 50/204

(57) ABSTRACT

A battery having a plurality of battery modules arranged in a battery housing. Each battery module comprises a battery cell, which is at least partially enclosed by a module housing of the respective battery module and has two connection poles on a top side of the module housing. To guide a gas flow emerging from the battery cell of at least one of the battery modules along a predetermined degassing path, the module housing of each battery module has a first degassing opening at an end face perpendicular to the top face of the module housing, and the battery housing has a second degassing opening.

### FIELD

The invention relates to a battery and to a motor vehicle having such a battery.

### BACKGROUND

A battery in the sense of the present invention comprises a multiplicity of battery modules which are arranged in a battery housing of the battery. A respective battery module may comprise at least one battery cell, which can be designed as a pouch cell, as a prismatic cell or also as a round cell. Such a battery cell comprises a galvanic cell which can have two electrodes that are charged differently from one another, i.e. an anode and a cathode, which can be electrically insulated from one another by a separator or a separator film and arranged to form a cell winding. The cell winding described is enclosed by a cell housing of the respective battery cell and embedded in an electrolyte or an electrolyte solution. Such a battery cell can provide an electrical voltage between 3 and 5 volts, in particular between 3.5 and 4.5 volts. To provide electrical drive energy for an at least partially electrically drivable motor vehicle, several such battery cells of such a battery can be electrically connected in series and/or be connected in parallel. It is known that a gas can be formed in an interior of a respective cell housing due to a cell fault or an aging process of the battery cell. In this case, a cell chemistry in the battery cell concerned can, for example, increase the flammability of the gas compared to ambient air and specify a temperature of the gas. In order to reduce a cell pressure that is increased due to the formation of gas, known battery cells have a degassing opening on a cell housing, through which the gas can be discharged into the surroundings of the battery cell.

For example, DE 10 2012 222 111 A1 describes a battery cell with a locking body for fixing electrode assemblies and a degassing element, wherein gases occur within the battery cell being able to be conducted to the degassing element by means of a channel structure of the locking body.

In this case, however, the locking body additionally arranged in the battery cell can increase installation space and weight of the battery cell.

Alternative approaches for discharging a gas through an opening on an outside of a cell housing without the use of a locking body are described, for example, in the following documents from the prior art.

From DE 10 2012 015 816 A1 it is known to arrange several battery cells of a battery module of a motor vehicle battery in a stack-like manner one behind the other or next to one another in such a way that the connection poles of the battery cells are along two parallel rows of poles and the predetermined degassing points of the battery cells between these pole rows are parallel to the pole rows running predetermined breaking point row are arranged.

DE 10 2013 203 106 A1 discloses a housing for an accumulator cell with at least one safety valve, wherein he safety valve opens into a channel section of a degassing channel. The channel section can be arranged on an outside of a housing between two electrical connection poles protruding from the housing or running through the housing on the housing.

In the two cited documents, an opening designed as a predetermined degassing rupture point or a safety valve is always arranged on the outside of a cell housing between two electrical connections, and a size of the opening is therefore predetermined by a relative distance between the two connections.

### SUMMARY

Against this background, the invention is based on the object of providing an improved concept for a battery of the type described at the outset in order to further increase the operational reliability of the battery in the event of a gas leak from at least one battery cell of the battery. It is also the object of the present invention to provide a motor vehicle with such a battery.

The improved concept provides a battery. The battery is preferably a battery of the type mentioned at the beginning. The battery comprises a multiplicity of battery modules arranged in a battery housing. Each battery module has a battery cell, wherein the battery cell is at least partially enclosed by a module housing of the respective battery module and has two connection poles on a top side of the module housing. A battery module for the purpose of the invention is understood to be a unit within the battery that is delimited by the module housing and comprises at least one and preferably several battery cells. In particular, the battery module can have two battery cells, which together can form what is known as a hybrid cell. The battery cell can in particular be a pouch cell, a prismatic cell or a round cell, wherein the battery cell can be at least partially delimited by a cell housing. In particular, the battery cell can have a cell chemistry with a predetermined mixing ratio of nickel, cobalt and manganese (for example 6:2:2 or 8:1:1). A respective housing, i.e. the cell housing, the module housing and the battery housing, can enclose the components arranged therein as a container. In particular, the respective housing can be made of a metal, for example steel, or contain the metal. On the top side of the module housing of each battery module, two connection poles are arranged, by means of which the battery modules can be electrically connected to one another.

To guide a gas flow emerging from the battery cell of at least one of the battery modules along a predetermined degassing path, the module housing of each battery module has a first degassing opening and the battery housing has a second degassing opening. The gas flow can be a directed movement of a fluid (gas) and particles (for example soot, sparks) carried along in it, wherein a degassing path can indicate a movement profile of the gas flow. The degassing path can use the two degassing openings, i.e. the first degassing opening and the second degassing opening, to define a path for the gas flow within the battery in order to direct the gas flow out of the battery in a defined or predetermined manner. A respective degassing opening in the sense of the invention can be understood as a closable recess or a gap in a respective housing, i.e. the module housing and the battery housing, through which the gas flow can flow from an interior delimited by the respective housing into the surroundings of the respective housing. Alternatively, it can be a gas-permeable section on the respective housing, which can be designed as a membrane, for example.

According to the improved concept, it is provided that the first degassing opening is positioned on an end face of the module housing of each battery module that is perpendicular to the top side of the module housing and is designed to guide the gas flow from an interior delimited by the module housing into a degassing channel of the battery housing. The interior of the module housing can comprise the battery cell and an gap between an outside of the cell housing of the battery cell and an inside of the module housing. At least one of the following elements can be arranged in this gap: a compression element for applying a predetermined pretensioning force to the battery cell; a thermal insulation element to limit or prevent unwanted heat transfer; a thermal conductive element for dissipating heat from the battery cell (for example a thermal conductive pad or what is known as a gap filler); a carrier element for increasing the stability of the battery cell and/or of the module housing. First of all, a gas flow can outgas, i.e. flow out, from the battery cell into the gap in an indirected manner at a structural weakness zone of the cell housing, for example in the region of a weld seam, and/or in dependence on a mechanical bearing, for example in the region of a pressure concentration. The gas flow can emerge from the cell housing at any point on the cell housing, in particular regard-less of a position of a cell fault (for example internal short circuit in the battery cell). In the gap, i.e. a part of the interior not occupied by the battery cell and the cell housing, the gas flow flows to the first degassing opening, which is arranged on the end face of the module housing of each battery module. In this case, it is explicitly not provided that the first degassing opening is arranged on the top side of the module housing that has the two connection poles. The front side can connect the top side of the module housing to a bottom side of the module housing, wherein the top side and the bottom side can be arranged in particular parallel to one another and perpendicular to the front side. In particular, the end face can be one of two end faces which, together with the longer longitudinal sides compared to the end faces, can form a jacket surface of the module housing. The first degassing opening arranged on the end face can comprise at least a partial section of the end face. As an alternative or in addition, the first degassing opening can extend over the entire end face.

When the gas flow is diverted from the interior of the module housing through the first degassing opening into the degassing channel of the battery housing, the first degassing opening can predetermine a first flow direction of the gas flow. The degassing channel can be a section within the battery housing for guiding the gas flow, which can spatially separate the gas flow, for example from the battery modules of the battery that differ from the at least one battery module, a cooling device of the battery or a control device of the battery. In particular, the degassing channel is designed to guide the gas flow independently of the at least one battery module from which the gas flow is discharged and thus preferably borders on each battery module, for example on the respective end face of each battery module. After flowing through the degassing channel at least in certain areas, the gas flow escapes through the second degassing opening into the surroundings of the battery. The degassing channel preferably has a second degassing opening on each of two opposite sides, so that two second degassing openings can be present. The second degassing opening is thus designed to divert the gas flow from the degassing channel into the surroundings of the battery adjoining the battery housing, i.e. to allow it to escape. The second degassing opening is preferably arranged on an end face of the degassing channel in order to provide a particularly long flow path for the gas flow from the battery. When the gas flow is diverted from the degassing channel of the battery housing through the second degassing opening into the surroundings of the battery, the gas flow can have a second flow direction that deviates from the first flow direction. In particular, the two flow directions can be extending perpendicular to each other so that between the first vent and the second vent a change of direction or a change of direction must be carried out of the gas stream.

The battery according to the improved concept has the advantage that the battery, despite its compact design, can reliably divert the gas flow from the battery cell of the at least one battery module into the vicinity of the battery and is easy to manufacture. Due to the reduced installation space of the battery compared to known concepts, the battery can provide a high energy density and, for example, when used in an at least partially electrically driven motor vehicle, it can increase the range of the motor vehicle. In particular, by means of the improved concept, a functionality and an integrity of those of the battery modules that differ from the at least one battery module with the outgassing battery cell can be maintained.

An advantageous embodiment provides that the degassing channel is at least partially enclosed by a channel wall, the channel wall having a gap opening for connection to the module housing in a longitudinal direction of the degassing channel. The degassing channel can be designed, for example, as a split tube. The channel wall can have a first arm and a second arm, wherein the two arms are able to define the gap opening. The gap opening can extend at least partially over a length of the degassing channel. In order to arrange the module housing with the end face particularly easily on the degassing channel, a gap width of the gap opening perpendicular to the longitudinal direction is greater than or equal to a height of the module housing parallel to the end face of the module housing having the first degassing opening. If the gap width of the gap opening and the height of the module housing are the same, then the channel wall can form a butt joint in the area of the first arm with the top side of the module housing and in the area of the first arm with the bottom side of the module housing. In this case, the degassing channel can advantageously be designed to be particularly small, wherein the design of the first degassing opening (for example over the entire end face) is able to be flexible independently of the degassing channel. If the gap width of the gap opening exceeds the height of the module housing, then the channel can form an overlap joint with the module housing, wherein the first arm can overlap in areas on the top side and the second arm can be arranged overlapping in areas on the bottom side of the module housing. Here, the top side and the bottom side of the module housing can be at least partially covered, for example superimposed, by the degassing channel. In this way, a fluid-tight connection, that is to say in particular tight against a gas outlet, can be established between the module housing and the degassing channel in a particularly simple manner.

A further advantageous embodiment provides that a carrier element for stabilizing the battery is arranged on the end face of the module housing having the first degassing opening, wherein the carrier element has a first flange and a second flange, with a web of the carrier element connecting the first flange to the second flange connects. The carrier element positioned on the module housing is thus provided, by means of which the battery, in particular the module housing, is stable and/or of the degassing channel, can advantageously be increased. The stability of the battery is a measure of the ability of the battery to withstand a force acting on the battery. This force can be introduced into the battery, for example, from the outside, for example from the surroundings, via an outside of the battery housing. Alternatively or additionally, the force within the battery can be applied to an inside of the battery housing, for example by the gas flow. The carrier element is intended to the battery against such an external and/or to protect internal stress. The carrier element can be designed, for example, as a steel profile or as a steel profile. Alternatively, the carrier element can be in the form of a profiled plastic or a plastic profile. The profile of the carrier element can include, for example, an I-profile in the case of a double-T-support or a U-profile. The first flange and the second flange of the carrier element are so-called arms which are connected to one another via a central part, for example the web. In particular, the two flanges are parallel to one another and the web is arranged perpendicular to the two flanges. In this case, the two flanges can protrude from the web at least on one side, that is to say in particular protrude at right angles.

A further advantageous embodiment provides that the degassing channel is connected fluidically tight to the module housing via the carrier element. In this way, an unintentional escape of the gas flow between the degassing channel and the module housing can advantageously be prevented or limited. The gap opening is formed by the first arm and the second arm of the channel wall, wherein the first arm is arranged at least partially overlapping at least in some areas on the first flange of the carrier element and/or the second arm overlapping on the second flange of the carrier element. Here, a respective one of the two flanges of the carrier element can be at least partially covered, i.e. superimposed, by the respective one of the two arms of the degassing channel arranged thereon. In particular, an underside of the respective one of the two flanges of the carrier element facing the web can at least partially adjoin an outer side of the respective one of the two arms of the degassing channel facing away from an interior of the degassing channel. Alternatively, the degassing channel can at least partially superimpose the respective of the two flanges of the carrier element on an upper side facing away from the web with an inner side facing the interior of the degassing channel. Alternatively, one of the two flanges of the carrier element with its underside can partially cover the outside of one of the two arms of the degassing channel and another of the two arms of the degassing channel with its inner side partially cover another of the two flanges of the carrier element.

A further advantageous embodiment provides that the web of the carrier element has a passage opening greater than or equal to the first degassing opening for the escape of the gas flow. The web of the carrier element thus has a gap through which the gas flow can be guided from the interior of the module housing via the first degassing opening into the degassing channel. In order to keep a pressure increase of the gas flow low or to prevent it from flowing through the passage opening, the passage opening is larger than the first degassing opening or at least the same size. In particular, when the battery is assembled as intended, a cross section of the first degassing opening normal to the first flow direction can be enclosed by a cross section of the passage opening normal to the first flow direction. The gas flow can thus advantageously be diverted particularly easily through the passage opening of the carrier element embodied in this way. A further advantageous embodiment provides that the module housing is positioned with the end face of the module housing having the first degassing opening parallel to the web of the carrier element. Thus, the end face of the module housing with the first degassing opening and the web of the carrier element are parallel to one another, so that a normal distance between the web and the end face is always the same. Preferably, an outer side of the web facing the module housing is arranged directly on the end face. Furthermore, the first flange and the second flange of the carrier element rest at least partially with the respective inner side on the top side of the module housing and the bottom side of the module housing opposite the top side. By resting the carrier element in this way on the module housing, a fluid-tight connection can be established between the carrier element and the module housing in a particularly simple manner. In particular, the respective inner sides of the two flanges can be parallel to the top side and the bottom side of the module housing in order to produce a flat contact between the carrier element and the module housing in a respective contact area.

A further advantageous embodiment provides that the first degassing opening of the module housing and, alternatively or additionally, the second degassing opening of the battery housing can each be closed by a safety valve. Thus, at least one of the degassing openings or both degassing openings can be coverable by means of the safety valve. This results in the advantage that the gas flow can be braked at least partially by means of the safety valve when it emerges from at least one respective degassing opening. Furthermore, by means of the safety valve, an early exit of the gas flow below a predetermined limit value, for example a maximum pressure, of the gas flow can be prevented or an exit of the gas flow can be made possible when the limit value is exceeded. The safety valve can be present, for example, as at least one bursting element, which can be designed as a bursting disc or a bursting foil. In this way, the gas flow can flow out in a controlled manner after the safety valve has been triggered.

A further advantageous embodiment provides that a spark arrester of the battery is arranged between the first degassing opening of the module housing and the second degassing opening of the battery housing. This means that the spark arrester is located between the two degassing openings along the predetermined degassing path and, when guiding the gas flow, is to flow through it, i.e. to be passed through. In particular, the spark barrier can be arranged on the end face of the respective module housing having the first degassing opening immediately before the gas stream flows into the degassing channel. Alternatively, the spark arrester or an additional spark arrester can be arranged on the second degassing opening. The spark arrester is designed to remove the particles (for example soot and/or sparks) from the gas flow. By means of the spark barrier, a flow speed of the gas stream can advantageously be reduced compared to an initial speed and a thermal energy of the gas stream can be reduced compared to a thermal initial energy. For example, the spark arrester can be made from a fiber optic and/or be formed ceramic fiber fabric. In this way, for example, a possible readiness of the gas flow for self-ignition after it has escaped from the battery into the environment can be reduced or prevented.

A further advantageous embodiment provides that an installation space for electrical contacting of the battery modules is arranged between the battery housing and the top side of the module housing of each battery module, wherein the two connection poles of each battery module protrude into the installation space. The electrical contact and the specified degassing path can thus be spatially separated from one another within the battery. When the gas flow is diverted from the battery, a flow around the two connection poles of each battery module directed in the installation space can thus advantageously be prevented. The installation space is limited by the top side of the module housing and the battery housing, while the degassing path of the gas flow is introduced into the degassing channel via the first degassing opening arranged on the front side of the module housing. Furthermore, an outer wall of the degassing channel can limit the installation space for the electrical contact, at least in sections.

According to the improved concept, a motor vehicle with a battery is also provided. The battery is designed to supply electrical power to an electrical consumer of the motor vehicle. The battery is preferably an embodiment of the battery according to the improved concept. The electrical consumer can in particular be a drive motor of the motor vehicle, which can be designed as a hybrid drive or an electric drive. The motor vehicle can preferably be designed as an automobile, in particular a passenger car or a truck, or as a passenger bus or as a motorcycle.

The invention also includes further developments of the motor vehicle according to the invention, which have characteristics as already described in the context of the refinements of the battery according to the invention and vice versa. For this reason, the corresponding refinements of the motor vehicle according to the invention are not described again here.

The invention also comprises combinations of the features of the described embodiments.

### BRIEF DESCRIPTION OF THE FIGURES

Exemplary embodiments of the invention are described hereinafter. In the figures:

FIG. 1 is a schematic illustration of an exemplary embodiment of a motor vehicle according to the improved concept;

FIG. 2 is a schematic perspective view of an exemplary embodiment of a battery according to the improved concept;

FIG. 3 is a first schematic sectional view of the exemplary embodiment of the battery according to the improved concept; and

FIG. 4 is a second schematic sectional view of the exemplary embodiment of the battery according to the improved concept.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those shown. Furthermore, the described embodiments can also be supplemented by further features of the invention that have already been described.

In the figures, the same reference signs designate elements that have the same function. For the sake of clarity, functionally identical and multiply provided elements, in particular in FIG. 2, are provided incompletely but at least once with a corresponding reference sign.

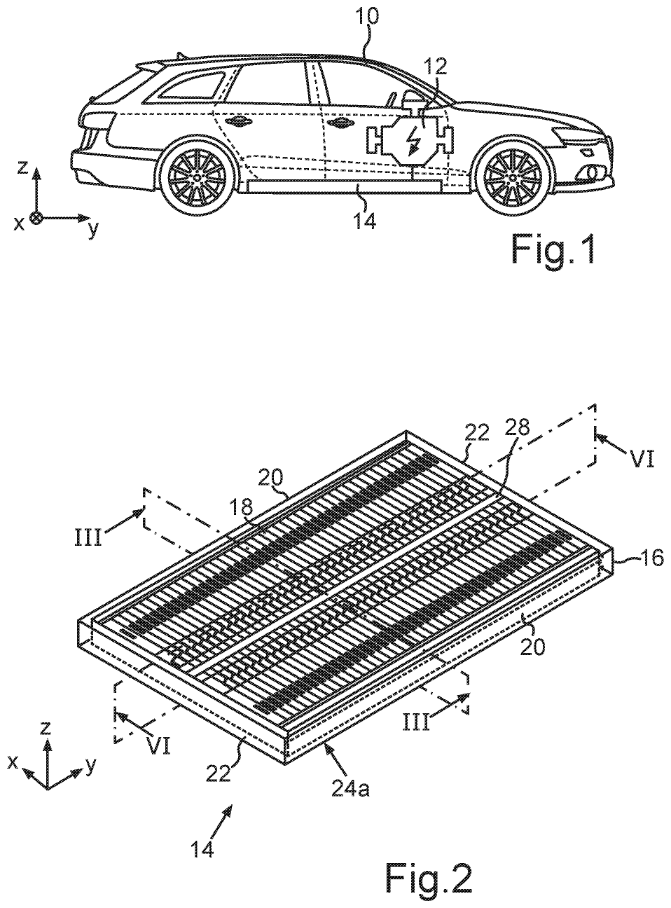

FIG. 1 shows an example of a motor vehicle 10 in the form of a passenger car with an electrical consumer 12 in the form of a drive motor and a battery 14. The battery 14 can be designed as a so-called high-voltage battery to supply electricity to the drive motor. The motor vehicle 10 can thus be at least partially electrically drivable and the drive motor can be designed as an electric drive or a hybrid drive.

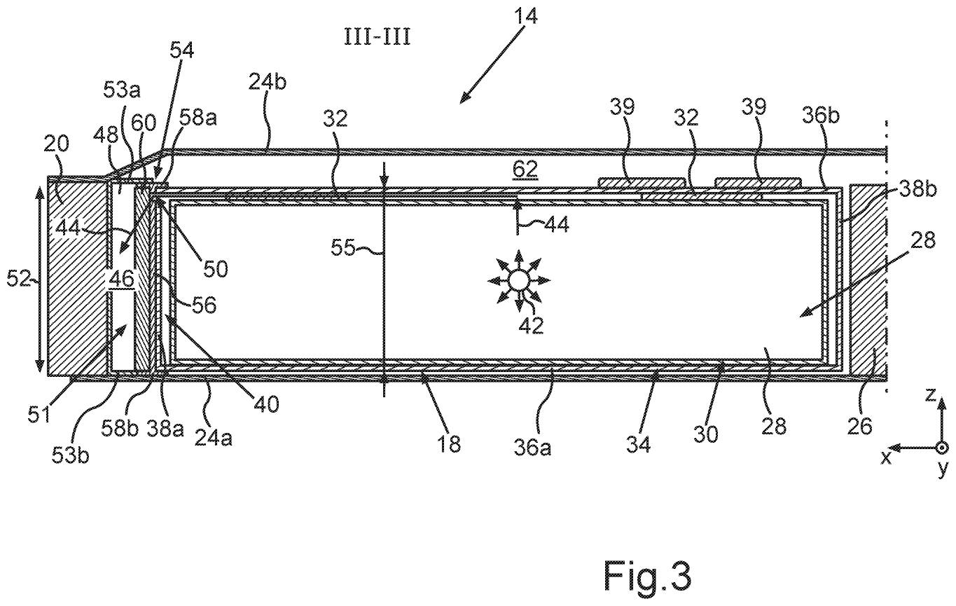

Referring to the components shown and described in connection with FIG. 1, FIG. 2 shows an example of battery 14 in perspective view. The battery 14 includes a plurality of battery modules 18 mounted in a battery housing 16. The battery housing 16 includes two longitudinal sides of the housing 20 in the yz plane and two end sides of the housing 22 in xz-plane, which, when the battery 14 is assembled as intended, connect a housing base 24a, which is shown concealed, to a housing cover 24b, which is not shown until FIG. 3. By way of example, in FIG. 2 the battery modules 18 are positioned in two parallel rows next to one another, wherein the two rows are separated from one another by means of a central web 26 of the battery housing 16.

With reference to the components shown and described in connection with FIGS. 1 and 2, FIG. 3 shows excerpts of one of the battery modules 18 of the battery 14 in a sectional illustration III-III. The battery module 18 comprises the at least one battery cell 28 shown and designed as a pouch cell, which has two cell poles 32 on an upper side of a cell housing 30 enclosing the battery cell 28. The battery cell 28 is at least partially enclosed by a module housing 34. The battery cell 28 is thus arranged in an interior 40 delimited by the module housing 34. The module housing 34 comprises a top side 36b and a bottom side 36a (both in the xy plane), which are connected to one another via two end faces 38a, 38b of the module housing 34 (both in the yz plane). On the top side 36b of the module housing 34 there are also two connection poles 39 for making electrical contact between the battery module 18 shown and other battery modules 18.

If there is a schematically indicated cell fault 42 in the battery cell 28, a gas flow 44 resulting therefrom and indicated by an arrow initially emerges in an uncontrolled manner, for example at a weak zone on the top of the cell housing 30 between the two cell poles 32 from the battery cell 28. In order to initially guide the gas flow 44 along a predetermined degassing path in a controlled manner from the interior 40 delimited by the module housing 34 into a degassing channel 46 of the battery housing 16, a first degassing opening 50 is provided on the end face 38a of the module housing 34.

The degassing channel 46 is at least partially enclosed by a channel wall 48, wherein the channel wall 48 has a gap opening 51 for connection to the module housing 34 in a longitudinal direction of the degassing channel 46, i.e. in the y-direction. In this case, a gap width 52 of the gap opening 51 between two arms 53a, 53b of the channel wall 48 is greater than a height 55 of the module housing 34 on the end face 38a.

To stabilize the battery 14, a carrier element 54 is provided, which is arranged on the end face 38a of the module housing 34. The carrier element 54 is designed as an I-profile and has a web 56 (in the yz plane) and two flanges 58a, 58b (in the xy plane) at the end of the web 56. The web 56 arranged parallel to the end face 38a comprises a passage opening similar to the first degassing opening 50 for the escape of the gas flow 44. In addition, the two flanges 58a, 58b with their respective inner sides facing one another rest at least partially on the top side 36b and the bottom side 36a of the module housing 34.

On a side of the web 56 facing away from the module housing 34, i.e. upstream, a spark arrester 60 is arranged on the carrier element 54, which can be enclosed in regions by the respective inner sides of the flanges 58a, 58b facing one another. Furthermore, the flanges 58a, 58b adjoin two arms 53a, 53b of the channel wall 48, wherein the flange 58b forms a butt joint with the arm 53b and the flange 58a overlaps the arm 53a at least in some areas, wherein an underside of the flange 58a from an inside of the arm 53a is at least partially covered.

Between the top side 36b of the module housing 34 and the housing cover 24b of the battery housing 16 there is also an installation space 62 for making electrical contact between the battery module 18 and further battery modules 18, wherein the two connection poles 39 of the battery module 18 project into the installation space 62 for this purpose.

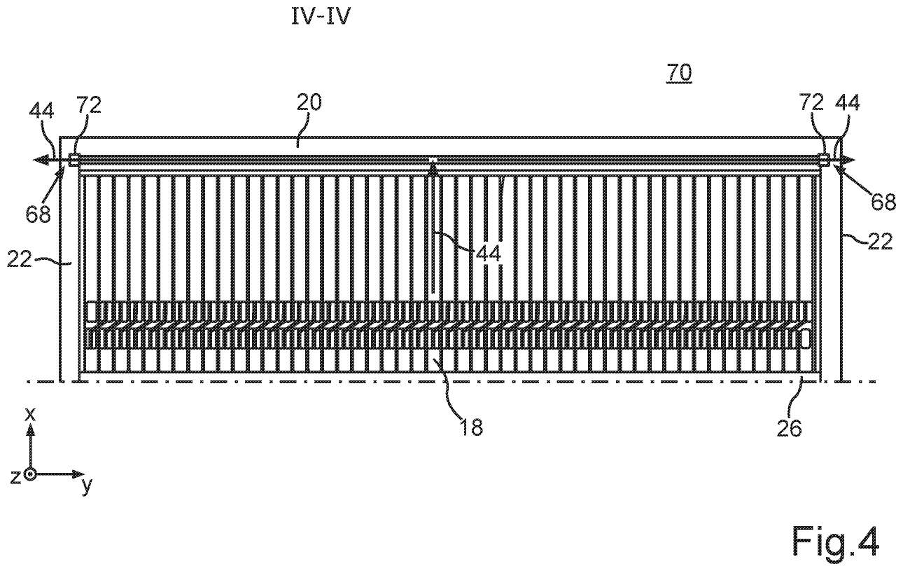

With reference to the components shown and described in connection with FIGS. 1 to 3, FIG. 4 shows a sectional view IV-IV of a row of the battery modules 18 of the battery 14 disposed in the battery housing 16. After the gas flow 44 flows with a first flow direction in the x-direction from the module housing 34 of the battery module 18 through the first degassing opening 50 into the degassing channel 46, the first flow direction of the gas flow 44 is transferred in two opposite second flow directions (in the y-direction and opposite to the y-direction). The battery housing 16 has two second degassing openings 68 on each of the two end housing sides 22, through which the gas flow 44 escapes from the degassing channel 46 into an environment 70 of the battery 14 adjoining the battery housing 16. Furthermore, a safety valve 72 designed as a bursting element is provided on each of the two second degassing openings 68.

Overall, the examples show how a degassing concept can be provided for the battery 14.

1. A battery comprising:
a plurality of battery modules arranged in a battery housing, wherein each battery module includes a battery cell, wherein the battery cell is at least partially enclosed by a module housing of the respective battery module and has two connection poles on a top side of the module housing, wherein
to guide a gas flow emerging from the battery cell of at least one of the battery modules along a predetermined degassing path, the module housing of each battery module has a first degassing opening and the battery housing has a second degassing opening, wherein
the first degassing opening is positioned on an end face of the module housing of each battery module that is perpendicular to the top side of the module housing and is designed to discharge the gas flow from an interior limited by the module housing into a degassing channel of the battery housing, wherein the second degassing opening is designed to allow the gas flow to escape from the degassing channel into an environment of the battery adjoining the battery housing.

2. The battery according to claim 1, wherein
the degassing channel is at least partially enclosed by a channel wall, wherein the channel wall has a gap opening for connection to the module housing in a longitudinal direction of extent of the degassing channel, wherein
a gap width of the gap opening perpendicular to the direction of longitudinal extent is greater than or equal to a height of the module housing parallel to the end face of the module housing having the first degassing opening.

3. The battery according to claim 2, wherein
a carrier element for stabilizing the battery is arranged on the end face of the module housing having the first degassing opening, wherein
the carrier element has a first flange and a second flange, wherein
a web of the carrier element connects the first flange to the second flange.

4. The battery according to claim 3, wherein
the degassing channel is fluidically tightly connected to the module housing via the carrier element, wherein
the gap opening is formed by a first arm and a second arm of the channel wall, wherein
the first arm is arranged at least partially overlapping on the first flange of the carrier element and/or the second arm is arranged at least partially overlapping on the second flange of the carrier element.

5. The battery according to claim 3, wherein the web of the carrier element has a passage opening greater than or equal to the first degassing opening for the gas flow to discharge.

6. The battery according to claim 3, wherein the module housing is positioned with the end face of the module housing having the first degassing opening parallel to the web of the carrier element, and the first flange and the second flange of the carrier element at least partially rest with a respective inner side on the top side of the module housing and a top side of the module housing opposite the top side.

7. The battery according to claim 1, wherein the first degassing opening of the module housing and/or the second degassing opening of the battery housing can be respectively closed by a safety valve.

8. The battery according to claim 1, wherein a spark arrester of the battery is arranged between the first degassing opening of the module housing and the second degassing opening of the battery housing.

9. The battery according to claim 1, wherein an installation space for electrical contacting of the battery modules is arranged between the battery housing and the top side of the module housing of each battery module, wherein the two connection poles of each battery module protrude into the installation space.

10. A motor vehicle with a battery according to claim 1, wherein the battery is designed to supply an electrical consumer of the motor vehicle with electrical energy.

11. The battery according to claim 4, wherein the web of the carrier element has a passage opening greater than or equal to the first degassing opening for the gas flow to discharge.

12. The battery according to claim 4, wherein the module housing is positioned with the end face of the module housing having the first degassing opening parallel to the web of the carrier element, and the first flange and the second flange of the carrier element at least partially rest with a respective inner side on the top side of the module housing and a top side of the module housing opposite the top side.

13. The battery according to claim 5, wherein the module housing is positioned with the end face of the module housing having the first degassing opening parallel to the web of the carrier element, and the first flange and the second flange of the carrier element at least partially rest with a respective inner side on the top side of the module housing and a top side of the module housing opposite the top side.

14. The battery according to claim 2, wherein the first degassing opening of the module housing and/or the second degassing opening of the battery housing can be respectively closed by a safety valve.

15. The battery according to claim 3, wherein the first degassing opening of the module housing and/or the second degassing opening of the battery housing can be respectively closed by a safety valve.

16. The battery according to claim 4, wherein the first degassing opening of the module housing and/or the second degassing opening of the battery housing can be respectively closed by a safety valve.

17. The battery according to claim 5, wherein the first degassing opening of the module housing and/or the second degassing opening of the battery housing can be respectively closed by a safety valve.

18. The battery according to claim 6, wherein the first degassing opening of the module housing and/or the second degassing opening of the battery housing can be respectively closed by a safety valve.

19. The battery according to claim 2, wherein a spark arrester of the battery is arranged between the first degassing opening of the module housing and the second degassing opening of the battery housing.

20. The battery according to claim 3, wherein a spark arrester of the battery is arranged between the first degassing opening of the module housing and the second degassing opening of the battery housing.
